(19) United States
(12) Patent Application Publication
(10) Pub. No.: US 2015/0337560 A1
(43) Pub. Date: Nov. 26, 2015

(54) Inside Release Handle for Door Lock

(71) Applicant: ApexOEM, Inc., Fullerton, CA (US)

(72) Inventor: Rodolfo Linares, Whittier, CA (US)

(73) Assignee: ApexOEM, Inc., Fullerton, CA (US)

(21) Appl. No.: 14/284,551

(22) Filed: May 22, 2014

(51) Int. Cl. E05B 5/00

(52) U.S. Cl. CPC E05B 5/006

(57) ABSTRACT

An assembly and a method of opening a locked door from inside a container is provided. The door has an exterior surface and an interior surface, with a latch coupled to the interior surface. The door includes a lock assembly that has an outer door handle, and an inside release handle that can be rotated from inside the container, and separately from the outer door handle, to disengage the latch of the door to open the locked door.

### BACKGROUND OF THE INVENTION

1. Field of the Invention

The present invention is directed to locking latches that are used with doors, and in particular, to an inside release handle that allows a locked door to be opened from the inside.

2. Description of the Prior Art

There are many types of sheds, shelters or other containers that have swinging doors that can be locked. Examples include portable sheds, or even containers that are carried on the wagon of large trucks or pickup trucks. These containers are often used to store tools or goods.

Many of these sheds and containers are provided with a latch handle that can be locked (e.g., using a key and a keyhole). Often, these containers are large enough where an individual can enter the interior of the container to load cargo, or to look for tools. Sometimes, an individual is inside the container and then someone else inadvertently locks the door.

Thus, there remains a need for a way to open a locked door from the inside to allow the individual to escape from the locked container.

### SUMMARY OF THE DISCLOSURE

It is one objective of the present invention to provide a release mechanism that can be operated from inside a locked door.

To accomplish the objectives set forth above, the present invention provides an assembly and a method of opening a locked door from inside a container. The door has an exterior surface and an interior surface, with a latch coupled to the interior surface. The door includes a lock assembly a handle latch housing that is mounted into the door, and having a recess that faces away from the exterior surface of the door, with a pivotabie lock handle positioned inside the recess. A locking mechanism is coupled to the lock handle so that the locking mechanism can pivot when the lock handle pivots. An inside release handle is coupled to the locking mechanism such that the inside release handle can be pivoted together with the locking mechanism when the lock handle is pivoted, but where the inside release handle can be pivoted separately from the locking mechanism. A swivel is coupled to the inside release handle, and a connection rod couples the swivel to the latch of the door. The inside release handle is rotated separately from the locking mechanism to cause the connection rod to disengage the latch of the door.

### BRIEF DESCRIPTION OF THE DRAWINGS

FIG. 1 is an exploded rear perspective view of a lock assembly according to one embodiment of the present invention.

FIG. 2 is a front perspective view showing the assembly of FIG. 1 in use on the outside of a door.

FIG. 3 is a rear perspective view showing the assembly of FIG. 1 in use on the inside of a door.

FIG. 4 illustrates the release handle of the assembly of FIG. 1.

FIG. 5 is a top plan view of the adapter of the assembly of FIG. 1.

FIG. 6 is a rear plan view illustrating the position of the release handle before it is pivoted to cause the door latches to open.

FIG. 7 is a rear plan view illustrating the position of the release handle after it is pivoted to cause the door latches to open.

FIG. 8 is a front perspective view of the assembly of FIG. 1.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

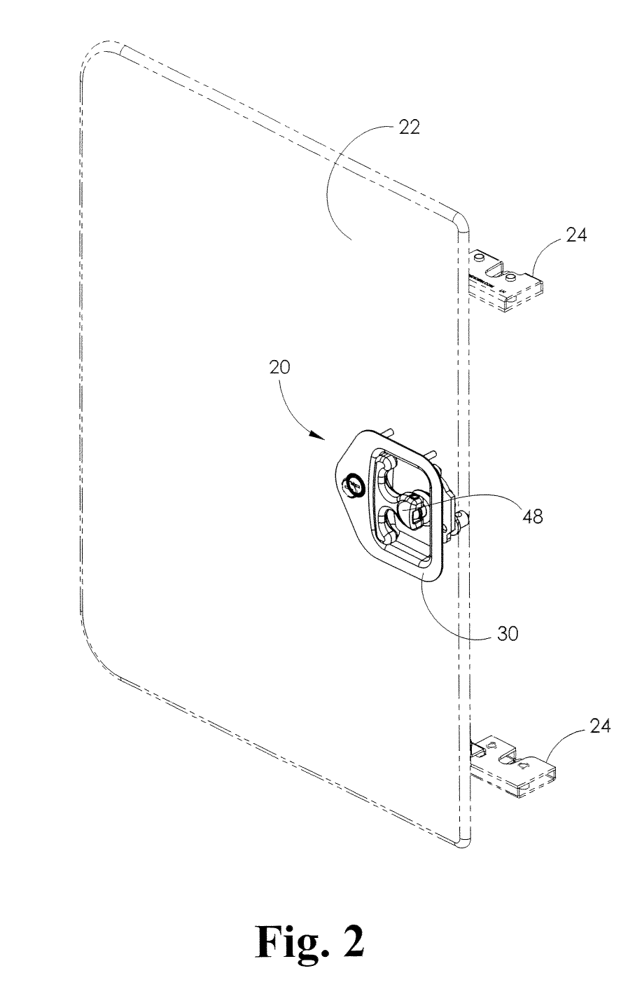

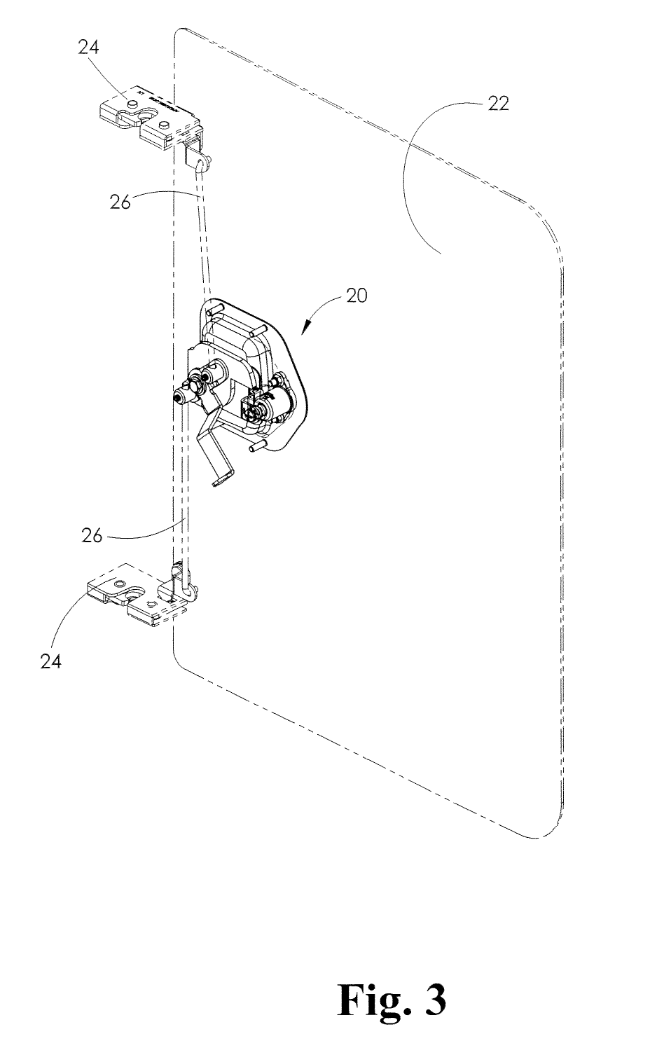

FIGS. 2 and 3 illustrate a lock assembly 20 according to the present invention, shown in use with a door 22. The door 22 can be a conventional door that typically has two latches 24 which are coupled to the lock assembly 20 via connecting rods 26. When the lock assembly 20 is locked, the latches 24 are locked in place and the door 22 cannot be opened. When the lock assembly 20 is unlocked, the connecting rods 26 disengage the latches 24 to allow the door 22 to be opened.

The present invention provides a lock assembly 20 which can open the door latches 24 from inside the door 22 so that a person who has been inadvertently locked inside the door 22 can open the door 22.

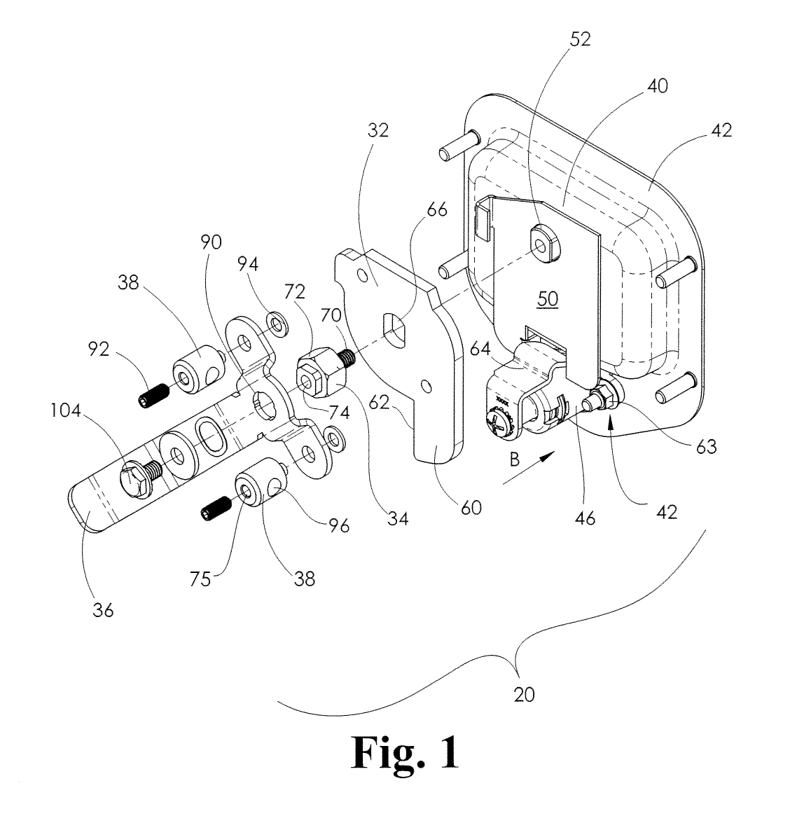

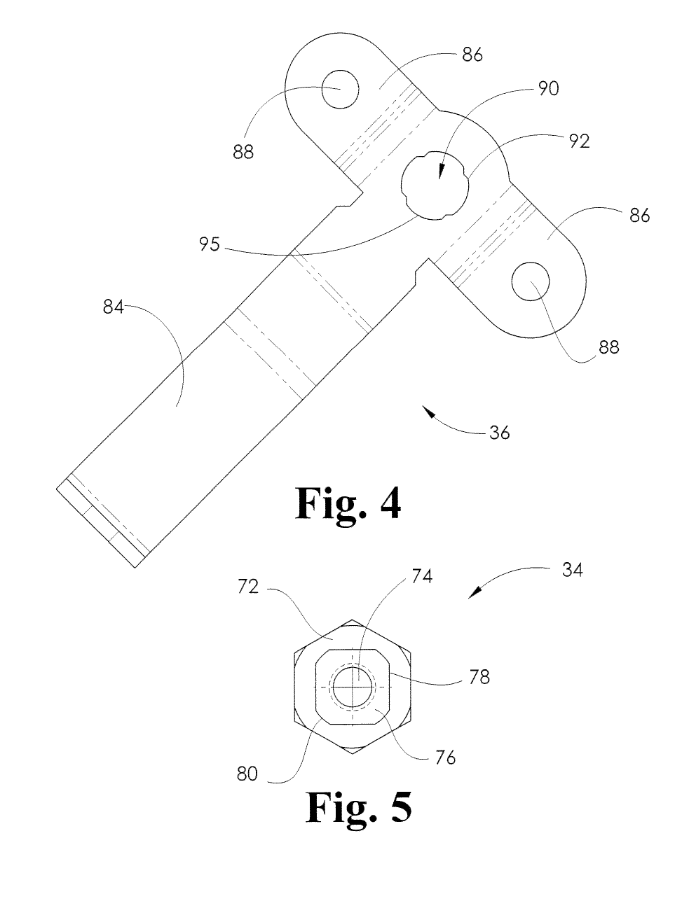

Referring to FIGS. 1-5 and 8, the lock assembly 20 has a handle latch housing 30, a latch cam 32, an adapter 34, an inside release handle 36, and two swivels 38.

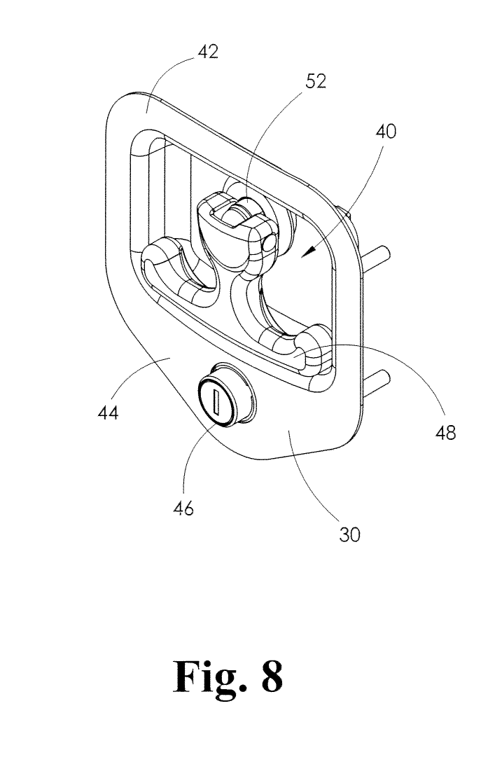

The latch housing 30 has a generally rectangular recess 40 surrounded by a flange border 42. The flange border 42 has a V-shaped section 44 below the recess 40, and a conventional keylock 46 is positioned is positioned on the V-shaped section 44. A T-shaped handle 48 is positioned inside the recess 40 in a manner such that the T-shaped handle 48 can be pivoted upward and downward from the locked orientation shown in FIG. 8, and then lifted upwardly and turned/rotated to disengage the latches 24 to allow the door 22 to be opened. The keylock 46 is positioned through an opening in the V-shaped section 44 and extends through the housing 30 to the interior (see FIG. 1), and is secured in position by mounting nuts 63. The keylock 46 also has a lock plate 64 that has an L-shaped section that couples the keylock 46 (see FIG. 1). A mounting plate 50 is positioned on the rear of the recess 40. A stem 52 extends through the housing 30 into the recess 40, and then extends through an opening in the mounting plate 50. The stem 52 is pivotably connected to the T-shaped handle 48.

The latch cam 32 functions as a locking member, and is shaped like the number “7” and has a leg 60 with a locking surface 62 that is adapted to abut the lock plate 64 when the T-shaped handle 48 is locked (i.e., it cannot rotate or pivot).

See FIGS. 1, 6 and 7. An opening 66 is provided at about the center of the latch cam 32. The opening 66 is shaped with two generally straight and parallel vertical sides that are connected by upper and lower curved sides. This shape corresponds with the shape of the stem 52 so that the stem 52 can be seated inside the opening 66. As a result, the stem 52 rotates together with the latch cam 32, so that when the T-shaped handle 48 is turned or rotated, the latch cam 32 is turned or rotated in the same direction.

The adapter 34 is positioned between the latch cam 32 and the release handle 36. The adapter 34 is essentially a bolted nut with a threaded stem 70 and a head 72. The threaded stem 70 extends through the opening 66 and is threadably received by the threaded opening inside the stem 52. A raised platform 76 extends from the head 72. A through bore 74 extends through the platform 76 and the head 72. The platform 76 has a generally square shape with four sides 78, and each of the sides 78 is connected by an angled edge 80.

The release handle 36 is generally T-shaped with a central section 84 and two wings 86. Each wing 86 is provided with an opening 88, and a central opening 90 is provided at the central section 84 at a location between the two wings 86. The opening 90 is generally circular but has a plurality (e.g., four) indents or ridges 92 extending inwardly from the circular peripheral edge 95 of the opening 90. A bolt 104 extends through the opening 90 and into the through-bore 74 to secure the release handle 36 to the adapter 34. A swivel 38 is secured to each wing 86 at the location of each opening 88 via riveting and a washer 94. In addition, a bolt 92 is adapted to be threadably received inside a threaded bore 75 of each swivel 38. Each swivel 38 has a through-hole 96 to which one end of a connecting rod 26 can be coupled. The bolt 92 extends through the bore 75 to clamp down on the connecting rod 26 so as to control the connecting rod 26.

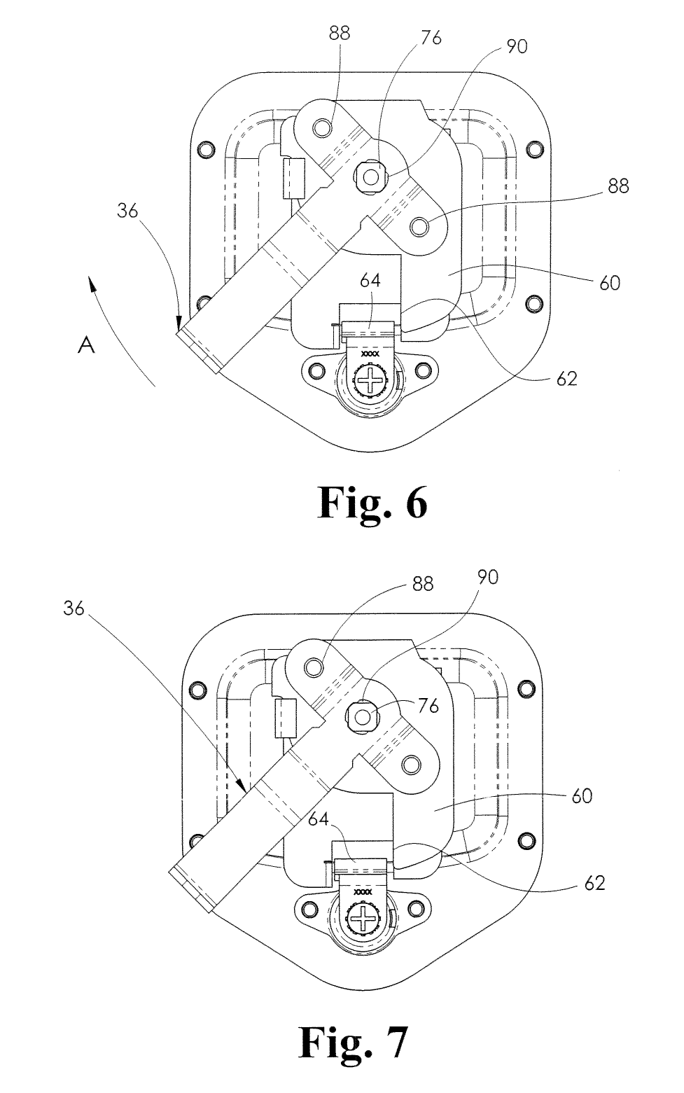

As best seen in FIGS. 1, 6 and 7, the platform 76 and the opening 90 are sized and shaped so that the platform 76 can be fitted inside in the opening 90 in a manner so that the angled edges 80 are fitted between adjacent indents 92. As a result, the indents 92 function as stop members so that the angled edges 80 can only travel between adjacent indents 92 along the circular peripheral edge 95. See FIGS. 5-7. FIG. 6 shows the release handle 36 in its normal position with the T-shaped handle 48 locked inside the housing 30 after the keylock 46 has been locked. In this position, the platform 76 is seated inside the opening 90 with angled edges 80 between adjacent indents 92. When the user needs to activate the release handle 36 to open the door 22 from the inside, the user pivots the release handle 36 in the direction shown by the arrow A in FIG. 6, which causes the angled edges 80 to move along the curved wall of respective portion of the peripheral edge 95 until they abut against an indent 92. A 45-degree pivot will cause the release handle 3 to reach the position shown in FIG. 7, and in this position, the swivels 38 (carried on the openings 88 as shown in FIG. 7) will have also pivoted by 45 degrees, thereby pulling the connecting rods 26 in opposite directions to cause the latches 24 to be disengaged, and to allow the door 22 to be opened. The ridges or indents 92 essentially function as stop members to prevent over-rotation.

In other words, the assembly 20 is constructed so that the latch cam 32 and the release handle 36 are configured to be pivoted separately. The adaptor 34 rotates simultaneously with the latch cam 32. However, when the T-shaped handle 48 is pivoted to open the door 22, the release handle 36 is carried on the latch cam 32 via its coupling with the adapter 34, so that the release handle 36 can rotate with the latch cam 32. Here, when the keylock 46 is normally unlocked, the keylock 46 and its accompanying lock plate 64 are lowered in the direction of arrow B (see FIG. 1), so that the T-shaped handle 48 can be pivoted, thereby causing the latch cam 32, and the release handle 36 carried on the latch cam 32, to pivot. The pivoting of the release handle 36 would again pull the connecting rods 26 in opposite directions to cause the latches 24 to be disengaged, and to allow the door 22 to be opened.

Thus, the present invention provides a simple but effective mechanism for allowing a locking assembly to be opened from the inside of a locked door.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A door assembly, comprising:
a door having an exterior surface and an interior surface, with a latch coupled to the interior surface;
a lock assembly having:
a handle latch housing that is mounted into the door, and having a recess that faces away from the exterior surface of the door, with a pivotable lock handle positioned inside the recess;
a locking mechanism coupled to the lock handle so that the locking mechanism can pivot when the lock handle pivots;
an inside release handle that is coupled to the locking mechanism such that the inside release handle can be pivoted together with the locking mechanism when the lock handle is pivoted, but where the inside release handle can be pivoted separately from the locking mechanism;
a swivel coupled to the inside release handle; and
a connection rod that couples the swivel to the latch of the door; and
wherein the inside release handle is rotated separately from the locking mechanism to cause the connection rod to disengage the latch of the door.

2. The assembly of claim 1, wherein the locking mechanism includes an adapter that is secured to the lock handle, the adapter coupled to the inside release mechanism in a manner such that the inside release handle can be pivoted together with the adapter and the locking mechanism when the lock handle is pivoted, but where the inside release handle can be pivoted separately from the adapter.

3. The assembly of claim 2, wherein:
the adapter has a head having a raised platform extending therefrom, with the platform having a generally square shape with four sides, and where each of the sides is connected by an angled edge;
the inside release handle has a central section and a wing, with a central opening provided at the central section and having a generally circular peripheral edge having a plurality of indents extending inwardly from the peripheral edge of the central opening, with the platform and the central opening sized and shaped so that the platform can be fitted inside the central opening in a manner such that the angled edges are fitted between adjacent indents.

4. The assembly of claim 2, wherein the lock assembly further includes a keylock that is positioned on a portion of the handle latch housing, and extending through the handle latch housing, and wherein the locking mechanism is a latch cam that has a leg with a locking surface that abuts a portion of the keylock, with the latch cam positioned between the adapter and the handle latch housing.

5. A door assembly, comprising:
a door having an exterior surface and an interior surface, with a latch coupled to the interior surface;
a lock assembly having:
a handle latch housing that is mounted into the door, and having a recess that faces away from the exterior surface of the door, with a pivotable lock handle positioned inside the recess, the lock handle pivotable about a stem that extends through the door and the handle latch housing;
an adapter having a head and a stem, the stem of the adapter being secured to the stem of the lock handle, the head having a raised platform extending therefrom, with the platform having a generally square shape with four sides, and where each of the sides is connected by an angled edge;
an inside release handle having a central section and a wing, with a central opening provided at the central section and having a generally circular peripheral edge having a plurality of indents extending inwardly from the peripheral edge of the central opening, with the platform and the central opening sized and shaped so that the platform can be fitted inside the central opening in a manner such that the angled edges are fitted between adjacent indents;
a swivel coupled to the wing; and
a connection rod that couples the swivel to the latch of the door; and
wherein the inside release handle is rotated separately from the adapter to cause the connection rod to disengage the latch of the door.

6. The assembly of claim 5, wherein the lock assembly further includes:
a keylock that is positioned on a portion of the handle latch housing, and extending through the handle latch housing; and
a latch cam that has a leg with a locking surface that abuts a portion of the keylock, the latch cam having an opening through which the stems of the adapter and the lock handle can extend, with the latch cam positioned between the adapter and the handle latch housing.

7. The assembly of claim 5, wherein the angled edges of the platform are moved along the peripheral edge of the central opening between adjacent pairs of indents as the central opening is rotated about the platform.

8. A method of opening a locked door from inside a container, comprising the steps of:
providing a door having an exterior surface and an interior surface, with a latch coupled to the interior surface, wherein the door includes a lock assembly having:
a handle latch housing that is mounted into the door, and having a recess that faces away from the exterior surface of the door, with a pivotable lock handle positioned inside the recess;
a locking mechanism coupled to the lock handle so that the locking mechanism can pivot when the lock handle pivots;
an inside release handle that is coupled to the locking mechanism such that the inside release handle can be pivoted together with the locking mechanism when the lock handle is pivoted, but where the inside release handle can be pivoted separately from the locking mechanism;
a swivel coupled to the inside release handle; and
coupling a connection rod to the swivel and the latch of the door;
rotating the inside release handle in a manner such that the inside release handle is rotated without pivoting the locking mechanism, so as to cause the connection rod to disengage the latch of the door.

9. The method of claim 8, wherein the locking mechanism includes an adapter that is secured to the lock handle, further including:
coupling the adapter to the inside release mechanism in a manner such that the inside release handle can be pivoted together with the adapter and the locking mechanism when the lock handle is pivoted, but where the inside release handle can be pivoted separately from the adapter.

10. The method of claim 9, wherein the adapter has a head having a raised platform extending therefrom, with the platform having a generally square shape with four sides, and where each of the sides is connected by an angled edge, and wherein the inside release handle has a central section and a wing, with a central opening provided at the central section and having a generally circular peripheral edge having a plurality of indents extending inwardly from the peripheral edge of the central opening, further including:
fitting the platform in the central opening in a manner such that the angled edges are fitted between adjacent indents, with the indents acting as stop members.

11. The method of claim 10, wherein the rotating step includes causing the angled edges of the platform to be moved along the peripheral edge of the central opening between adjacent pairs of indents as the central opening is rotated about the platform.
